(19) United States
(12) Patent Application Publication
(10) Pub. No.: US 2020/0218424 A1
(43) Pub. Date: Jul. 9, 2020

(54) TOUCH DETECTION METHOD AND COMPUTER-READABLE STORAGE MEDIUM

(71) Applicant: Chipone Technology (Beijing) Co., Ltd., Beijing (CN)

(72) Inventor: Pengfei FENG, Beijing (CN)

(73) Assignee: Chipone Technology (Beijing) Co., Ltd., Beijing (CN)

(21) Appl. No.: 16/628,006

(22) PCT Filed: Apr. 18, 2019
(86) PCT No.: PCT/CN2019/083166

§ 371 Date: Dec. 31, 2019

(30) Foreign Application Priority Data
May 22, 2018 (CN) 201810495363.5

(51) Int. Cl. G06F 3/041

(52) U.S. Cl. CPC G06F 3/04186; G06F 2203/04104

(57) ABSTRACT

The present disclosure relates to a touch detection method. The touch detection method includes: determining a touch position where a touch occurs on a touch panel in accordance with touch detection data; and when the touch position is at an edge of the touch panel, determining whether the touch is an edge false touch based on a change of the touch position and/or characteristics of a touch area, and if yes, ignoring the edge false touch. By identifying the edge false touch based on the touch position and characteristics of the touch area, the problem of a touch detection error caused by holding an edge of a device can be effectively alleviated.

### CROSS-REFERENCE TO RELATED APPLICATION

The present application claims priority to the Chinese Patent Application No. 201810495363.5, filed on May 22, 2018, and entitled “TOUCH DETECTION METHOD AND COMPUTER READABLE STORAGE MEDIUM”, which is incorporated herein by reference in its entirety.

### BACKGROUND OF THE DISCLOSURE

### Field of the Disclosure

The present disclosure relates to the technical field of touch detection, and in particular to a touch detection method and a computer readable storage medium.

### Description of the Related Art

With the development of technologies, a touch detection technology is widely applied to an electronic device such as a smartphone and a tablet computer. A touch screen tends to increasingly cover a forward surface of the electronic device, or even to cover the whole forward surface of the electronic device, i.e., a so-called full screen. However, when a user holds the electronic device, it is inevitable to touch an edge of the touch screen, and such a touch is not intended to execute a special touch operation. If the touch is identified as a normal touch, an unnecessary false operation will occur. Particularly, for a Touch and Display Driver Integration (TDDI) technology, the prevention on an edge false touch is increasingly demanding. Nonetheless, there hasn't yet been a solution to solve the problem effectively.

### BRIEF DESCRIPTION OF THE DISCLOSURE

In view of this, the present disclosure provides a touch detection method and a computer readable storage medium. By identifying an edge false touch based on a touch position and characteristics of a touch area, the problem of reporting a touch point mistakenly due to a fact that an edge of a device is held can be effectively alleviated.

According to one aspect of the present disclosure, there is provided a touch detection method, including: determining a touch position where a touch occurs on a touch panel in accordance with touch detection data; and when the touch position is at an edge of the touch panel, determining whether the touch is an edge false touch based on a change of the touch position and/or characteristics of a touch area; and if yes, ignoring the edge false touch.

Preferably, the step of determining whether the touch is an edge false touch based on characteristics of a touch area includes: determining the touch area around the touch position; and if the touch area has a shape meeting a preset requirement along the edge, determining that the touch is the edge false touch.

Preferably, the step of determining a touch position on a touch panel in accordance with touch detection data includes: calculating difference data between the touch detection data and reference data; and when the difference data has a difference data point greater than a first preset value, determining that the touch occurs; and determining a peak point in the difference data.

Preferably, determining the touch area includes: determining a connected area formed by data points greater than a second preset value around the peak point in the difference data, and taking the connected area as the touch area.

Preferably, the preset requirement includes: a length of the touch area is greater than a first preset length threshold, a width of the touch area is greater than a first preset width threshold, and a proportion of the first length threshold to the first width threshold is greater than a preset length-width ratio.

Preferably, the preset requirement includes: a length of the touch area is greater than a first preset length threshold, and a width of the touch area is greater than a first preset width threshold; or the length of the touch area is greater than a second preset length threshold, the width of the touch area is greater than a second preset width threshold, wherein, the proportion of the first length threshold to the first width threshold and a proportion of the second length threshold to the second width threshold are greater than the preset length-width ratio, the first length threshold is smaller than the second length threshold, and the first width threshold is smaller than the second width threshold.

Preferably, the length and the width of the touch area are separately defined by the number of rows and the number of columns of electrodes corresponding to the touch area on the touch panel.

Preferably, the step of determining whether the touch is an edge false touch based on a change of the touch position includes: determining whether a movement having the touch as an initial touch occurs; if yes, determining that the touch is the edge false touch under a condition in which a distance of the movement is smaller than or equal to a preset distance; and if the movement having the touch as the initial touch does not occur, determining that the touch is the edge false touch.

Preferably, the touch detection method further includes: when the distance of the movement is greater than the preset distance, reporting a track of the movement.

Preferably, the step of reporting a track of the movement includes: performing interpolation between the touch position of the initial touch and a touch position when the distance of the movement larger than the preset distance; and reporting the track of the movement based on the touch position of the initial touch, the touch position when the distance of movement greater than the preset distance, and the interpolation.

Preferably, under a condition in which the touch involves in multiple touch points, the step of determining whether the touch is an edge false touch based on a change of the touch position and/or characteristics of a touch area is executed for at least one of the multiple touch points.

Preferably, the edge includes edges on left and right sides of the touch panel in use.

According to another aspect of the present disclosure, there is provided a computer readable storage medium which stores an instruction; and the instruction executes the touch detection method when being executed by a processor.

According to the following detailed description on exemplary embodiments in conjunction with the accompanying drawings, other characteristics and aspects of the present disclosure will become apparent.

### BRIEF DESCRIPTION OF THE DRAWINGS

The accompanying drawings, which are incorporated in and constitute a part of the specification, illustrate exemplary embodiments, features, and aspects of the present disclosure together with the description, and serve to explain the principles of the present disclosure.

FIG. 1 illustrates an equivalent circuit diagram of a touch device according to an embodiment of the present disclosure.

FIG. 2 illustrates a schematic flowchart of a touch detection method according to an embodiment of the present disclosure.

FIG. 3 illustrates a schematic flowchart of a method for calculating a touch position according to an embodiment of the present disclosure.

FIG. 4 illustrates an example of difference data according to an embodiment of the present disclosure.

FIG. 5 illustrates a schematic flowchart of a touch detection method according to another embodiment of the present disclosure.

### DETAILED DESCRIPTION OF THE DISCLOSURE

Various exemplary embodiments, features, and aspects of the present disclosure will be described in detail below with reference to the accompanying drawings. The same numerals in the accompanying drawings represent an element having a same or similar function. Although various aspects of the embodiments are illustrated in the accompanying drawings, the accompanying drawings are unnecessarily drawn according to a proportion unless otherwise specified.

The exclusive term “exemplary embodiment” in the specification means that it is “used as an example, an embodiment or an illustration”. Any “exemplary” embodiment described here is unnecessarily explained as being superior to or better than other embodiments.

Additionally, in order to better describe the present disclosure, many particular details are provided in the following detailed description. It should be understood by the person skilled in the art that the present disclosure may still be implemented without some particular details. In some embodiments, a method, a means, an element and a circuit known to the person skilled in the art are not described in detail for the ease of the prominence of a theme of the present disclosure.

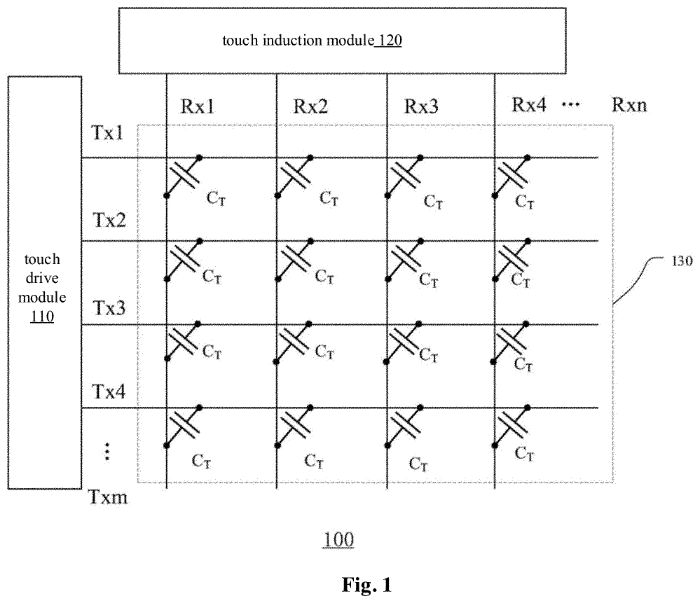

FIG. 1 illustrates an equivalent circuit diagram of a touch device according to an embodiment of the present disclosure.

The touch device 100 includes a touch drive module 110, a touch induction module 120 and a touch panel 130. The touch panel 130 includes multiple excitation electrodes and multiple induction electrodes. Multiple induction capacitors CT are formed between the excitation electrodes and the induction electrodes. The multiple induction capacitors CT are formed into an array. Various rows of excitation electrodes are coupled to the touch drive module 110 through drive lines Tx1 to Txm, respectively. The touch drive module 110 provides excitation signals to various rows of excitation electrodes in a scanning manner, thus, in a touch frame cycle, providing the excitation signals to different rows of excitation electrodes in sequence. Various columns of induction electrodes are coupled to the touch induction module 120 through induction lines Rx1 to Rxn, respectively, so that the touch induction module 120 receives induction signals of corresponding rows. Herein, both m and n are natural numbers. When a touch position is calculated, the induction signals are converted into touch detection data. With calculation on a difference between the touch detection data and reference data for various points in the array, difference data is obtained, and the difference data contains variation values of the induction capacitors CT of various points in the array. If the variation values of the induction capacitors CT exceeds a preset threshold, it is determined that a touch occurs.

The above are an example of the touch device to describe a touch detection principle in the embodiment of the present disclosure. It should be clear to the person skilled in the art that the embodiment of the present disclosure is not limited thereto, and a specific structure and an implementation manner of the touch device may be chosen as required. For example, the touch device may be applied to a touch screen, and the touch drive module 110 and the touch induction module 120 may be set as an independent module and may also be integrated together. In some embodiments, by using the TDDI technology, the touch drive module 110 and the touch induction module 120 may be integrated together with a display drive module of the touch screen. The touch panel and the display panel may be integrated together in multiple manners to form a touch display panel of the touch screen, for example, an on-cell or an in-cell manners, and will not be repeated herein.

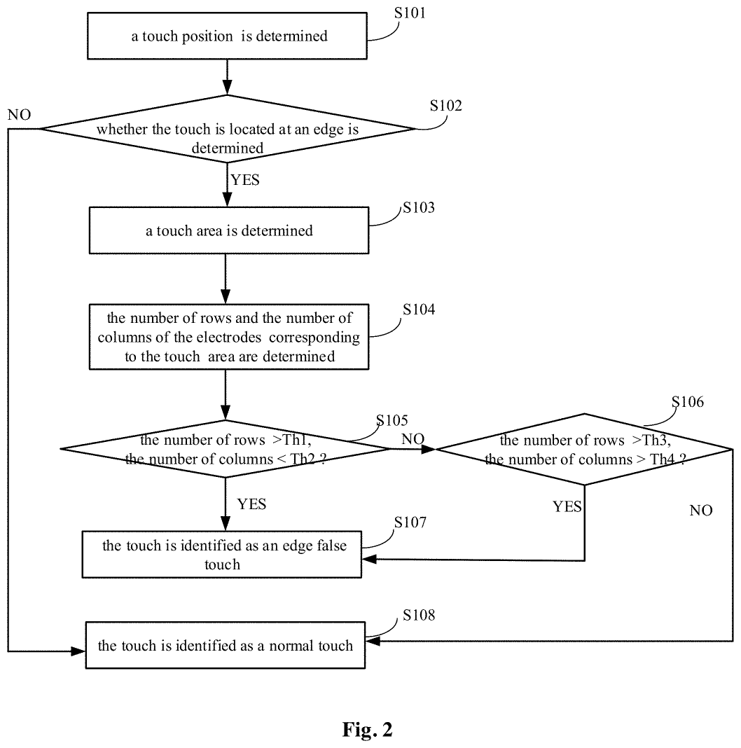

FIG. 2 illustrates a schematic flowchart of a touch detection method according to an embodiment of the present disclosure.

In step S101, a touch position where a touch occurs is determined in accordance with touch detection data. For example, whether the touch occurs may be determined by use of the above-described manner.

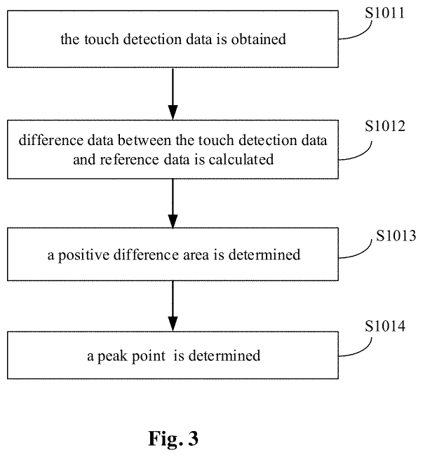

FIG. 3 illustrates a schematic flowchart of a method for calculating the touch position in accordance with an embodiment of the present disclosure.

In step S1011, the touch detection data is obtained. For example, it may be appropriate to receive induction signals from the induction lines Rx1 to Rxn and convert the induction signals into the touch detection data.

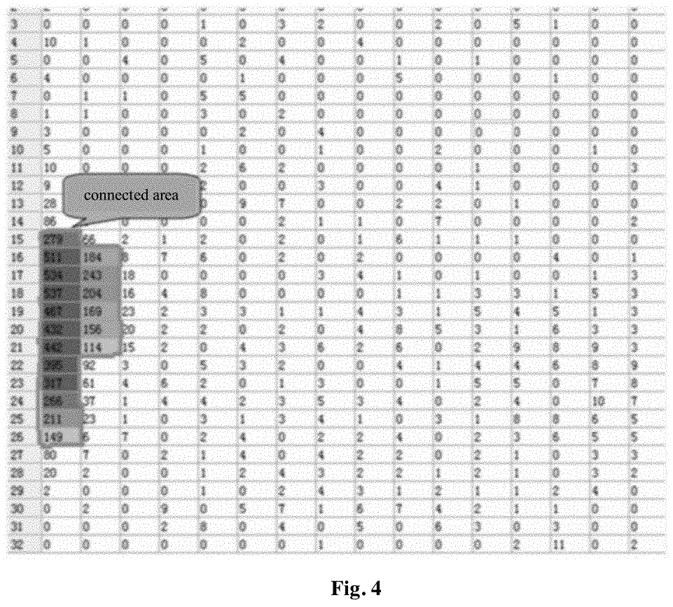

In step S1012, difference data between the touch detection data and reference data is calculated. As described above, it is suitable to calculate a difference between the touch detection data and the preset reference data for various points in the array to obtain the difference data. FIG. 4 illustrates an example of difference data according to an embodiment of the present disclosure. As shown in FIG. 4, the touch occurs on the left side of the touch panel, which results in that the difference data has a continuous positive-value area in a left area, that is, the values of the area are greater than 0.

In step S1013, a positive difference area is determined. For example, a continuous area formed by a positive difference in FIG. 4 may be determined, then whether the touch occurs may be determined by means of determining whether a data point exceeding a preset threshold is present in the area.

In step S1014, a peak point in the difference data is determined. For example, the peak point in the example of FIG. 4 is 537, and is located in an eighteenth row and a first column of the touch panel. The touch position can be obtained based on the position where the peak point is located, for example, based on analysis and calculation.

Referring back to FIG. 2, in the step S102, whether the touch is located at an edge of the touch panel is determined, if yes, the step S103 is executed, or otherwise, the step S108 is executed. Whether the touch occurs at the edge may be determined by means of determining whether the peak point is located in a certain range of the left side or right side of the touch panel. For example, the touch panel is generally integrated with the display panel in the touch screen, when whether the touch position is located at the edge is determined, the determination may be made based on a coordinate of a pixel point array on the display panel, and may also be made based on a coordinate of an electrode array on the touch panel. As an example, 20 columns of pixel points may be selected as a threshold, when the distance between the pixel point and the edge of the pixel array does not exceed the 20 columns of pixel points, it is determined that the touch occurs at the edge of the touch panel, or otherwise, it is determined that the touch does not occur at the edge. In the example of FIG. 4, the peak point is located on the eighteenth row and the first column in the electrode array of the touch panel, so that it can be determined that the touch occurs at the edge of the left side of the touch panel. Certainly, the embodiment of the present disclosure is not limited to the first column, and the position in a second column, a third column or other preset columns may also be determined as the edge position.

In step S103, a touch area is determined based on the touch position. For example, the peak point obtained in the step S1014 can be used as a center to determine a connected area formed by difference data points greater than the preset value around the peak point. For example, in the example of FIG. 4, a continuous area formed by difference data greater than 100 around the peak point 537 can be used as the connected area, as shown by a bold line frame in the figure.

In step S104, the number of rows and the number of columns of the electrodes corresponding to the connected area on the touch panel are calculated. Similarly, as shown in FIG. 4, the connected area occupies 15-26 rows and the first and second columns. Therefore, whether the connected area has a shape meeting a preset requirement (for example, an elongated shape) along the edge may be determined.

In step S105, whether the number of rows occupied by the connected area is greater than a threshold Th1 and the number of columns is smaller than a threshold Th2 is determined, if yes, the step S107 is executed, or otherwise, the step S106 is executed. Generally, as a hand of a user holds the device, there is a false touch at the edge of the touch screen, and when the device is held by the hand of the user, a touch area of the elongated shape is generated on the left side or right side of the touch screen. In this step, it is set that Th1 is greater than Th2 by at least a certain value, so that the elongated area along a column direction is defined. If the length and width of the connected area meet the above condition, it is considered that the connected area has the elongated shape along the edge of the touch screen, and the shape and size of the elongated connected area meet a basic standard defined by the Th1 and Th2, and consequently, whether the edge touch is the false touch may be determined.

In step S106, whether the number of rows occupied by the connected area is greater than a threshold Th3 and the number of columns occupied by the connected area is smaller than a threshold Th4 are determined, if yes, the step S107 is executed; or otherwise, the step S108 is executed. This step is optional. It may be allowed that Th3 is greater than Th1, Th4 is greater than Th2 and Th3 is greater than Th4 by at least a certain value. Compared with the above Th1 and Th2, a larger elongated area is defined by means of the Th3 and the Th4 in this step. This is because when the device is held by the hand, a thumb often touches the edge of one side of the screen, the other four fingers touch the edge of the other side of the screen, and the area touched by the thumb is often greater than the area touched by the other four fingers. In this step, by setting a larger elongated area as a reference standard, different sizes of edge false touches caused by various realistic reasons may be detected.

In this embodiment, the number of rows and the number of columns in the electrode array of the touch screen are used as the thresholds Th1, Th2, Th3 and Th4. However, the embodiment of the present disclosure is not limited thereto. As mentioned above, it may also be appropriate to take the number of rows and the number of columns of a corresponding pixel array on the display panel as the thresholds to determine whether the connected area is elongated, which will not be repeated herein.

In step S107, the touch is identified as an edge false touch, and the touch is ignored in a touch detection result. For example, the touch detection method in this embodiment of the present disclosure may be applied to an electronic device such as a mobile phone and a tablet computer, and a touch point identified as the edge false touch may not be reported to an operation system of the electronic device, thus guaranteeing the accuracy of the touch detection result.

In step S108, the touch is identified as a normal touch. Under a condition in which the touch is not located at the edge or does not have the elongated shape meeting the requirement, it may be considered that the touch is the normal touch. Correspondingly, the position of the touch at this time may be recorded in the touch detection result for later use.

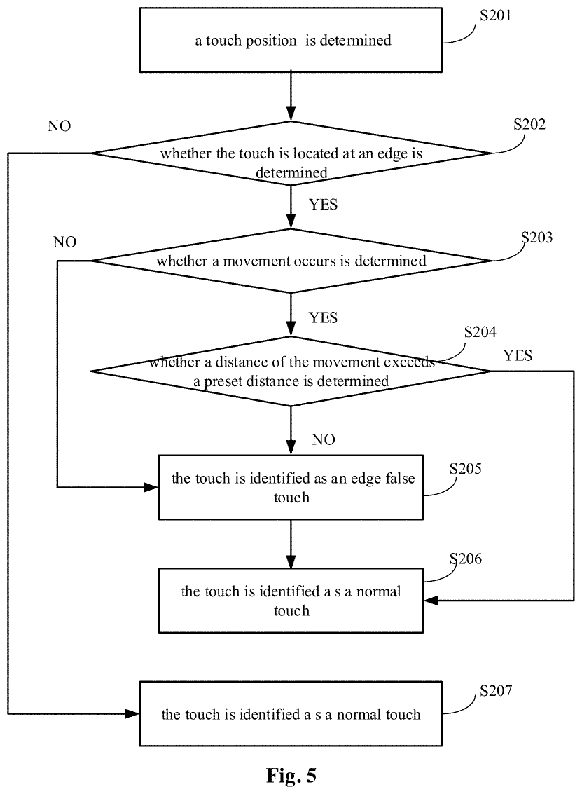

FIG. 5 illustrates a schematic flowchart of a touch detection method according to another embodiment of the present disclosure. The embodiment in FIG. 5 is similar to FIG. 2, and the difference mainly lies in the parts after the steps S105 and S106. In order to clearly describe the technical solution, the detailed description is mainly made to the different part.

The step S201 may be implemented in a manner same as that for describing the step S101 with reference to FIG. 2.

In step S202, whether the touch is located at an edge of the touch panel is determined, if yes, the step S203 is executed, or otherwise, the step S207 is executed. In this embodiment, it may be considered that the edge is edges on left and right sides of the touch panel. As when the device is held by the hand, the edge false touch is often attributed to the touch of fingers on left and right sides, the manner of detecting the false touch on the left and right sides of the screen is more suitable for an actual use habit of the user, and can detect the edge false touch more accurately. The determination manner may use the manner described in the step S102.

In Step S203, whether a movement having the current touch as an initial touch occurs is determined, if yes, the step S204 is executed; or otherwise, the step S205 is executed. In this step, the direction of the movement includes but not limited to a movement towards a center of the touch panel, towards upper and lower sides of the touch panel or along edges on two sides of the touch panel.

In Step S204, whether a distance of the movement exceeds a preset distance is determined, if yes, the step S206 is executed, or otherwise, the step S205 is executed. When the device is held by the hand, the touch of the finger at the edge often has a certain short distance of movement, and such a distance is very short generally and is insufficiently used as a touch gesture. Therefore, by setting a distance in this step, the movement within the distance is not reported. The track of the touch is reported only when the movement exceeds the preset distance. As a result, the report on the edge false touch may be effectively reduced, and the accuracy of the touch detection may be improved. In this embodiment, the coordinate of the pixel array on the display panel may be used as a determination standard, for example, when the distance of the movement exceeds 20 pixel points, it is considered that an ordinary touch occurs, and when the distance does not exceed the 20 pixel points, it is considered that the edge touch occurs. In some embodiments, the coordinate of the electrode array on the touch panel may also be used as the determination standard, which will not be repeated herein.

In step S205, the touch is identified as an edge false touch, and the touch is ignored in a touch detection result. In this embodiment, the touch point identified as the edge false touch is not reported, thus guaranteeing the accuracy of the touch detection.

In step S206, the touch is identified a s a normal touch, and a track of the movement is reported. For example, it may be appropriate to record an initial touch position when the movement is started as a first touch position, record a touch position when the movement exceeds the preset distance as a second touch position, perform interpolation between the first touch position and the second touch position, and report the track of the movement based on the first touch position, the second touch position and the interpolation. The interpolation method may be selected as required, for example, the interpolation may be performed via an averaging manner, etc. With such a manner, the track of the touch movement may not be reported all the time before the movement of the touch from the edge exceeds the preset distance, so that the reporting error caused by the short-distance movement of the finger when the device is held by the hand is prevented. When the movement exceeds the preset distance, the track of the touch movement is reported via a manner of interpolation between the first touch position and the second touch position. Therefore, the quick and accurate report on the track of the previous touch can be implemented, making the touch experience of the user smooth.

In Step S207, the touch is identified as a normal touch. Correspondingly, the position for the touch at this time may be recorded in the touch detection result for later use.

In the above embodiment, the single touch point is used as an example to describe the touch detection method in the embodiments of the present disclosure. However, the embodiments of the present disclosure are not limited thereto. In some embodiments, upon the determination that the touch involves in multiple touch points, it may be appropriate to track one or more touch points therein to execute the subsequent determination of the edge false touch, and make the overall determination of the edge false touch for the multi-point touch according to a determination result of the multiple touch points. For example, when the touch involves in the multi-point touch of four fingers, a position of each finger may be tracked to execute the above method described with reference to FIG. 2 or FIG. 4, thus determining whether the touch of each finger is the edge false touch. In some other embodiments, the overall determination may also be made in combination with a determination result for all or a part of touch points. For example, when all four touch points at the edge are determined as the edge false touch, the overall touch formed by the four touch points is identified as the edge false touch.

The edge false touch detection based on the change of the touch position and the edge false touch detection based on the characteristics of the touch area are described above separately with reference to FIG. 2 and FIG. 4. However, the embodiments of the present disclosure are not limited to the separate use of the above two detection manners. In some embodiments, the two manners may be used simultaneously to detect the edge false touch. For example, upon the determination that the touch position is located at the edge, the steps S202 to 207 may be executed while the steps S102 to 108 are executed, thus further improving the accuracy of the detection on the edge false touch.

An embodiment of the present disclosure further provides a computer readable storage medium, configured to store an instruction; and the instruction executes the above method when being executed by a processor.

As an example, this embodiment of the present disclosure may also be described in a context of a machine executable instruction. The machine executable instruction may be, for example, included in a program module executed in a device on a real or virtual processor of a target. Generally, the program module includes a routine, a program, a library, an object, a type, a component, a data structure and the like to execute a special task or implement a special abstract data structure. In each embodiment, the functions of the program modules may be merged or separated among the described program modules. The machine executable instruction for the program module may be executed in a local or distributive device. In the distributive device, the program module may be located in local and remote storage media.

Computer program codes for implementing the method of the present disclosure may be compiled by the use of one or more programming languages. These computer program codes may be provided to a processor of a universal computer, a dedicated computer or other programmable data processing devices, so that when the program codes are executed by the computer or other programmable data processing devices, the functions/operations in the flowchart and/or block diagram are implemented. The program codes may be executed completely on the computer or partially on the computer, used as an independent software package, and executed partially on the computer and partially on the remote computer or completely on the remote computer or server.

In the context of the present disclosure, the machine readable medium may be any physical medium including or storing a program used for or relating to an instruction executing system, apparatus or device. The machine readable medium may be a machine readable signal medium or machine readable storage medium. The machine readable medium may include but not limited to electronic, magnetic, optical, electromagnetic, infrared or semiconductor systems, apparatuses or devices, or any appropriate combination thereof. A more detail example of the machine readable medium includes electrical connection, portable computer magnetic disk, hard disk, Random-Access Memory (RAM), Read-Only Memory (ROM), Erasable Programmable Read-Only Memory (EPROM or flash memory), optical storage device, magnetic storage device having one or more lead wires or any appropriate combination thereof.

In the embodiments of the present disclosure, by identifying an edge false touch based on the touch position and characteristics of the touch area, the problem of a touch detection error due to the fact that an edge of a device is held can be effectively alleviated.

In the embodiments of the present disclosure, whether the touch area has an elongated shape meeting a preset requirement is taken as a determination standard for the edge false touch, the false touch due to the fact that the edge of the device is held can be identified accurately, and the identification accuracy is improved.

In the embodiments of the present disclosure, by setting ranges of large and small elongated areas, different sizes of the edge false touches due to various reasons can be effectively identified.

In some conditions, the user is not in a completely stationary state when holding the device, the finger has a short distance of movement on the screen, and the movement is not a touch gesture. In the embodiments of the present disclosure, with the determination on whether a short-distance movement towards a center of a screen and with the current touch as an initial touch position occurs, not only can the static edge false touch be identified, but the dynamic edge false touch can also be identified. Therefore, the accuracy of identification is improved.

In the embodiments of the present disclosure, when the distance of touch movement from the edge touch exceeds a preset standard, it is considered that the touch is a normal touch. With interpolation between an initial touch point and an end touch point, a track of a previous touch movement can be reported quickly and accurately, and thus the normal operation of the touch operation is guaranteed.

The flowchart and block diagrams in the accompanying drawings illustrate the architecture, functionality, and operation of possible implementations of systems, methods, and computer program products according to various embodiments of the present disclosure. In this regard, each block in the flowchart or block diagrams may represent a module, a program segment, or a portion of an instruction, which comprises one or more executable instructions for implementing the specified logical functions. In some alternative implementations, the functions noted in the blocks may occur out of the order noted in the accompanying drawings. For example, two blocks shown in succession may, in fact, be executed substantially and concurrently, or the blocks may sometimes be executed in a reverse order, depending upon the functionality involved. It will also be noted that each block of the block diagrams and/or flowchart and combinations of blocks in the block diagrams and/or flowchart can be implemented by special purpose hardware-based systems that perform the specified functions or acts or implemented by the use of combinations of special purpose hardware and computer instructions.

The above-described various embodiments of the present disclosure are illustrative but not exhaustive, and are not limited to the disclosed embodiments. Many modifications and changes are apparent to an ordinary person skilled in the art without departing from the scope and spirit of each embodiment of the present disclosure. The terms used in the specification are selected to explain the principle and actual application of each embodiment or technical improvement in the market to the greatest extent, or make other ordinary persons skilled in the art understand each embodiment of the present disclosure.

1. A touch detection method, comprising:
determining a touch position where a touch occurs on a touch panel in accordance with touch detection data; and
when the touch position is at an edge of the touch panel, determining whether the touch is an edge false touch based on a change of the touch position and/or characteristics of a touch area; and
if the touch is an edge false touch, ignoring the edge false touch.

2. The touch detection method according to claim 1, wherein the step of determining whether the touch is an edge false touch based on characteristics of a touch area comprises:
determining the touch area around the touch position; and
if the touch area has a shape meeting a preset requirement along the edge, determining that the touch is the edge false touch.

3. The touch detection method according to claim 2, wherein the step of determining a touch position on a touch panel in accordance with touch detection data comprises:
calculating difference data between the touch detection data and reference data; and
when the difference data has a difference data point greater than a first preset value, determining that the touch occurs; and
determining a peak point in the difference data.

4. The touch detection method according to claim 3, wherein determining the touch area comprises:
determining a connected area formed by data points greater than a second preset value around the peak point in the difference data; and
taking the connected area as the touch area.

5. The touch detection method according to claim 2, wherein the preset requirement comprises:
a length of the touch area is greater than a first preset length threshold, a width of the touch area is greater than a first preset width threshold, and a proportion of the first length threshold to the first width threshold is greater than a preset length-width ratio.

6. The touch detection method according to claim 2, wherein the preset requirement comprises:
a length of the touch area is greater than a first preset length threshold, and a width of the touch area is greater than a first preset width threshold; or
the length of the touch area is greater than a second preset length threshold, and the width of the touch area is greater than a second preset width threshold;
wherein, the proportion of the first length threshold to the first width threshold and a proportion of the second length threshold to the second width threshold are greater than a preset length-width ratio, the first length threshold is smaller than the second length threshold, and the first width threshold is smaller than the second width threshold.

7. The touch detection method according to claim 5, wherein the length and the width of the touch area are defined by the number of rows and the number of columns of electrodes corresponding to the touch area on the touch panel, respectively.

8. The touch detection method according to claim 1, wherein the step of determining whether the touch is an edge false touch based on a change of the touch position comprises:
determining whether a movement having the touch as an initial touch occurs;
if yes, determining that the touch is the edge false touch under a condition in which a distance of the movement is smaller than or equal to a preset distance; and
if the movement having the touch as the initial touch does not occur, determining that the touch is the edge false touch.

9. The touch detection method according to claim 8, wherein the touch detection method further comprises: when the distance of the movement is greater than the preset distance, reporting a track of the movement.

10. The touch detection method according to claim 9, wherein the step of reporting a track of the movement comprises:
performing interpolation between the touch position of the initial touch and a touch position when the distance of the movement larger than the preset distance; and
reporting the track of the movement based on the touch position of the initial touch, the touch position when the distance of movement greater than the preset distance, and the interpolation.

11. The touch detection method according to claim 1, wherein under a condition in which the touch involves in multiple touch points, the step of determining whether the touch is an edge false touch based on a change of the touch position and/or characteristics of a touch area is executed for at least one of the multiple touch points.

12. The touch detection method according to claim 1, wherein the edge comprises edges on left and right sides of the touch panel in use.

13. A computer readable storage medium, configured to store an instruction, the instruction executing the touch detection method according to claim 1 when being executed by a processor.
